(19) United States
(12) Patent Application Publication
(10) Pub. No.: US 2007/0286357 A1
(43) Pub. Date: Dec. 13, 2007

(54) Method and system to enable users to select between wireless and wireline voice mail menus

(75) Inventor: Renee Chiu-Tsa Lau, Livermore, CA (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/451,172

(22) Filed: Jun. 12, 2006

(51) Int. Cl. H04M 1/64

(52) U.S. Cl. 379/67.1

(57) ABSTRACT

A voice mail system provides a voice mail service and multiple modes for navigating the voice mail service. The modes comprise a first mode to navigate the voice mail service using a wireless voice mail menu and a second mode to navigate the voice mail service using a wireline voice mail menu.

### FIELD OF THE DISCLOSURE

The present disclosure is generally related to voice mail systems.

### BACKGROUND

Voice mail systems are provided by various telephone companies to enable voice messages to be recorded for their customers. Different voice mail systems have different voice mail menus and features.

### BRIEF DESCRIPTION OF THE DRAWINGS

FIG. 1 is a flow chart of an embodiment of a method of providing multiple voice mail modes;

FIG. 2 is a block diagram of an embodiment of a system for providing multiple voice mail modes; and

FIG. 3 is a block diagram of an illustrative embodiment of a general computer system.

### DETAILED DESCRIPTION OF THE DRAWINGS

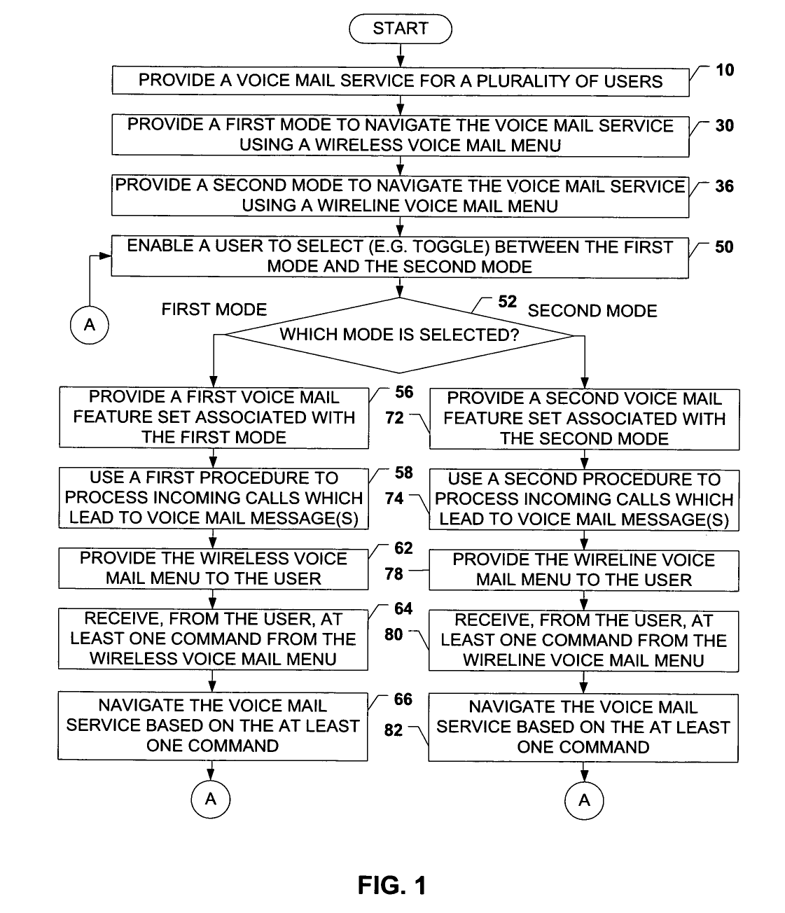

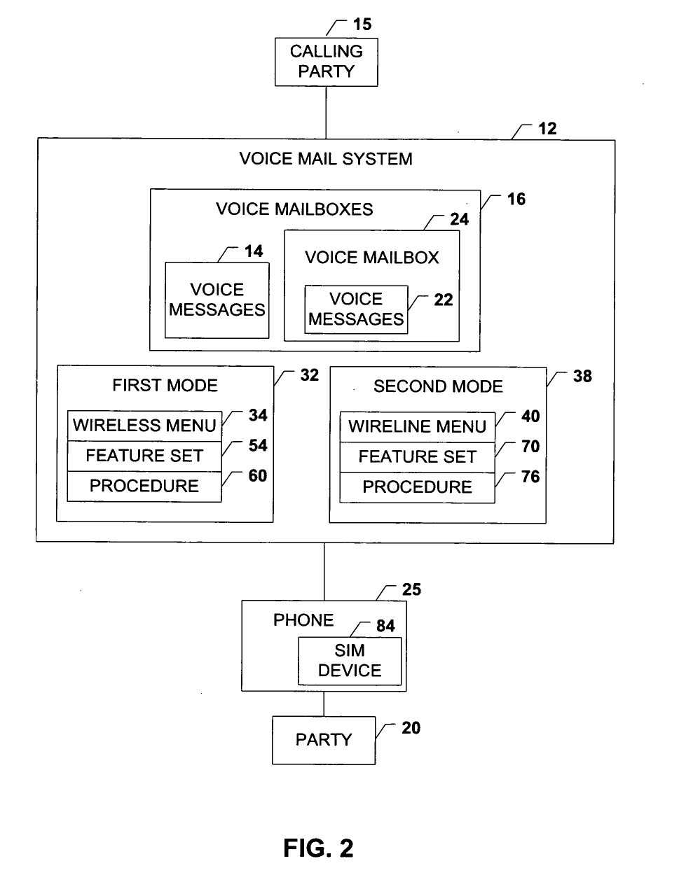

The following description refers to FIG. 1, which is a flow chart of an embodiment of a method of providing multiple voice mail modes, and FIG. 2, which is a block diagram of an embodiment of a system for providing multiple voice mail modes.

As indicated by block 10, the method comprises providing a voice mail service for a plurality of users. The voice mail service can be provided using a voice mail system 12 of a telephone service provider. The voice mail system 10 enables calling parties to leave voice messages 14 for particular users. The voice mail system 10 may prompt a calling party 15 to leave a message under one or more conditions, e.g. if an intended callee is busy or unavailable.

The voice mail system 12 provides a plurality of voice mailboxes 16 to store the voice messages 14. Each user is given access to those of the voice messages 14 stored in his/her particular one of the voice mailboxes 16 using his/her phone. For example, a party 20 is enabled to navigate the one or more recorded voice messages 22 in his/her voice mailbox 24 using his/her phone 25. Based on the navigation, the party 20 can listen to none, some or all of the recorded voice messages 22. Further, the party 20 may be enabled to perform operations such as deleting, forwarding, marking (e.g. as urgent) and/or saving any of the recorded voice messages 22 in his/her voice mailbox 24 using the phone 25.

The voice mail system 12 provides multiple voice mail modes. Each of the modes has its own associated voice mail menu of commands for navigating the voice mail system, its own associated voice mail feature set, and its own associated procedure of processing incoming calls so that calling parties can leave the voice messages. The voice mail system 12 enables each user to select which of the multiple voice mail modes that he/she prefers to use. Based on a mode selected by the user, the voice mail system 12 provides, to the user, the particular voice mail menu associated with the selected mode. Further, the voice mail system 12 provides the particular voice mail feature set to the user and/or to the parties calling the user based on the user-selected mode. Still further, the voice mail system 12 may process incoming calls for the user according to a particular procedure associated with the user-selected mode.

The voice mail system 12 may provide a wireless voice mail service only for wireless telephone customers. Alternatively, the voice mail system 12 may provide a wireline voice mail service only for wireline telephone customers. As another alternative, the voice mail system 12 may provide voice mail to both wireless and wireline customers.

For purposes of illustration and example, the voice mail system 12 is described as having two voice mail modes. Those having ordinary skill will recognize that more than two voice mail modes can be provided in alternative embodiments.

As indicated by block 30, the method comprises providing a first mode 32 to navigate the voice mail service. In the first mode, a user can navigate the voice mail service using a wireless voice mail menu 34.

As indicated by block 36, the method comprises providing a second mode 38 to navigate the voice mail service. In the second mode 38, a user can navigate the voice mail service using a wireline voice mail menu 40.

In general, the wireless voice mail menu 34 may provides commands and features that are more similar to existing wireless voice mail menus than existing wireline voice mail menus. Similarly, the wireline voice mail menu 40 may provide commands and features that are more similar to existing telco-provided wireline/landline voice mail menus than existing wireless voice mail menus. In an embodiment, the wireline voice mail menu 40 provides all voice mail features for landlines provided by a particular telecommunications company (telco).

At least one voice mail command provided by the wireless voice mail menu 34 may not be provided by the wireline voice mail menu 40. Examples of commands provided by the wireless voice mail menu 34 but not provided by the wireline voice mail menu 40 include, but are not limited to, a play-slower command and a play-faster command for playing back recorded voice mail messages.

At least one voice mail command provided by the wireline voice mail menu 40 may not be provided by the wireless voice mail menu 34. Examples of commands provided by the wireline voice mail menu 40 but not provided by the wireless voice mail menu 34 include, but are not limited to, a back-up (or reverse) command and a skip-forward command to move from one voice mail message to another voice mail message.

Some commands may be provided by both the wireless voice mail menu 34 and the wireline voice mail menu 40. However, the wireless voice mail menu 34 and the wireline voice mail menu 40 may differ in which numeric keys correspond to some or all of the navigation or playback commands. Examples of commands that may have different corresponding numeric keys include, but are not limited to, a save command and a delete command.

As indicated by block 50, the method comprises enabling each user to select which mode he/she desires for the voice mail service. For example, the party 20 can use the phone 25 to select between the first mode 32 and the second mode 38. The party 20 can make the selection by providing a voice command or a numeric key selection, for example, to the voice mail system 12. In an embodiment, the voice mail system 12 enables the party 20 to toggle between the first mode 32 and the second mode 38.

As indicated by block 52, different flow paths are taken based on the user-selected mode. If the first mode 32 was selected, the method comprises providing a first voice mail feature set 54 associated with the first mode 32 (block 56). As indicated by block 58, the method further comprises using a first procedure 60 associated with the first mode 32 to process incoming calls which lead to a recording of a voice mail message. As indicated by block 62, the method comprises providing the wireless voice mail menu 34 to the user. As indicated by blocks 64 and 66, the method comprises receiving from the user at least one command from the wireless voice mail menu 34, and navigating the voice mail service based on the at least one command.

If the second mode 38 was selected, the method comprises providing a second voice mail feature set 70 associated with the second mode 38 (block 72). As indicated by block 74, the method further comprises using a second procedure 76 associated with the second mode 38 to process incoming calls which lead to a recording of a voice mail message. As indicated by block 78, the method comprises providing the wireline voice mail menu 40 to the user. As indicated by blocks 80 and 82, the method comprises receiving from the user at least one command from the wireline voice mail menu 40, and navigating the voice mail service based on the at least one command.

Thus, the two modes 32 and 38 provide different ways for the party 20 to navigate the same voice mail system and to playback the same voice mail messages in its mailbox. The party 20, at substantially any time, can change which mode is to be associated with its mailbox by returning to block 50. Different parties can use their phones to select different modes for navigating and playing back their voice messages.

Optionally, the voice mail system 12 enables each user to customize a menu associated with its selected mode. For example, each user may be enabled to customize which specific numeric keys are to be associated with specific voice mail features. Features that may be associated with user-assigned keys include, but are not limited to, listen/replay, pause, reverse, skip forward, rewind, fast forward, advance, save, delete, mark as urgent, cancel, exit and skip. Thus, each mode may provide its own default key assignment, but be flexible in enabling each user to modify the default key assignment for his/her own purposes. Still further, each user can selectively enable or disable a feature that, by default, is otherwise excluded or included in the user-selected mode. Each user can customize his/her selected mode using his/her telephone.

Optionally, the user-defined modifications to the default can be stored in a SIM device 84 or otherwise locally stored in the user's phone. In an embodiment, the SIM device 84 can provide a software override so that voice mail features can be reassigned to fit a user's wants and needs. Software control can make certain features universal. A user can program his/her wireless phone like a universal television remote control.

Embodiments of the multiple mode voice mail method and system have many benefits. Users can standardize service feature keys to better match those to which they have become accustomed. For example, a wireless telephone customer can choose to navigate his/her wireless voice mail messages using a menu structure either identical or otherwise similar to a voice mail menu structure provided for his/her home or business landline phone. Instructions for wireline/landline voice mail menus may be found in a printed phone book, to which the wireless telephone customer can refer.

Further, users can revert to one or more legacy voice mail menus when one or more new voice mail menus are introduced by a telephone service provider. With the legacy voice mail menus, users can use keys and commands which have become second nature to them. For example, a user may want to use a “2” key to save a message, a “3” key to delete a message, a “7” key to reverse and a “9” key to skip forward.

Still further, users can select which mode better matches their preferences. For example, some users may select a mode that provides an option for password protection on voice mail, while other users may select a different mode that excludes the password protection option. Some users may select a mode that provides options to back-up (or rewind or reverse) and skip-forward (or fast forward) their voice messages, while other users may select a different mode that provides options to make playback slower and faster.

Some users may select a mode that informs a called party if their status is busy or if their status is unavailable. Other users may select a different mode that immediately directs a call to voice mail if their wireless phone is out-of-range or off, and that rings multiple times before directing a call to voice mail if their wireless phone is busy or engaged in a different call. Some users may select a mode that provides a call waiting feature, while other users may select a different mode that is absent the call waiting feature.

Some users may select a mode having a shorter holding period of saved messages than a different mode. These users may include users who receive a great number and/or lengthy voice mail messages, and thus need to free-up voice mailbox space.

Some users may select a mode having a jump-to-end-of-message feature and/or delete-an-in-progress-voice-message feature, while other users may select a different mode that is absent one or both of the aforementioned features.

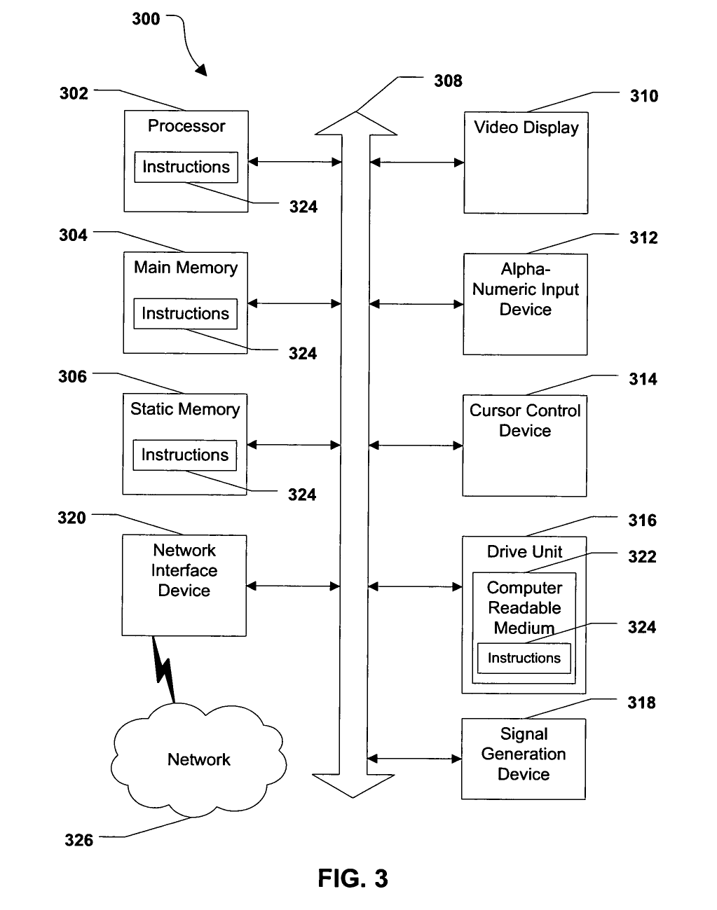

Referring to FIG. 3, an illustrative embodiment of a general computer system is shown and is designated 300. The computer system 300 can include a set of instructions that can be executed to cause the computer system 300 to perform any one or more of the methods or computer based functions disclosed herein. The computer system 300 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 300 can be implemented using electronic devices that provide voice, video or data communication. Further, while a single computer system 300 is illustrated, the term “system” shall also be taken to include any collection of systems or sub-systems that individually or jointly execute a set, or multiple sets, of instructions to perform one or more computer functions.

As illustrated in FIG. 3, the computer system 300 may include a processor 302, e.g., a central processing unit (CPU), a graphics processing unit (GPU), or both. Moreover, the computer system 300 can include a main memory 304 and a static memory 306, that can communicate with each other via a bus 308. As shown, the computer system 300 may further include a video display unit 310, such as a liquid crystal display (LCD), an organic light emitting diode (OLED), a flat panel display, a solid state display, or a cathode ray tube (CRT). Additionally, the computer system 300 may include an input device 312, such as a keyboard, and a cursor control device 314, such as a mouse. The computer system 300 can also include a disk drive unit 316, a signal generation device 318, such as a speaker or remote control, and a network interface device 320.

In a particular embodiment, as depicted in FIG. 3, the disk drive unit 316 may include a computer-readable medium 322 in which one or more sets of instructions 324, e.g. software, can be embedded. Further, the instructions 324 may embody one or more of the methods or logic as described herein. In a particular embodiment, the instructions 324 may reside completely, or at least partially, within the main memory 304, the static memory 306, and/or within the processor 302 during execution by the computer system 300. The main memory 304 and the processor 302 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 324 or receives and executes instructions 324 responsive to a propagated signal, so that a device connected to a network 326 can communicate voice, video or data over the network 326. Further, the instructions 324 may be transmitted or received over the network 326 via the network interface device 320.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
providing a voice mail service;
providing a first mode to navigate the voice mail service using a wireless voice mail menu; and
providing a second mode to navigate the voice mail service using a wireline voice mail menu.

2. The method of claim 1 wherein the voice mail service is a wireless voice mail service.

3. The method of claim 2 further comprising:
receiving, from a user, at least one command from the wireline voice mail menu; and
navigating the wireless voice mail service for the user based on the at least one command from the wireline voice mail menu.

4. The method of claim 1 further comprising:
enabling a user to select between the first mode and the second mode to navigate the voice mail service.

5. The method of claim 1 further comprising:
enabling a user to toggle between the first mode and the second mode.

6. The method of claim 1 wherein the wireline voice mail menu provides at least one voice mail command that is not provided by the wireless voice mail menu.

7. The method of claim 6 wherein the at least one voice mail command provided by the wireline voice mail menu but not provided by the wireless voice mail menu comprises a back-up command and a skip-forward command.

8. The method of claim 1 wherein the wireless voice mail menu provides at least one voice mail command that is not provided by the wireline voice mail menu.

9. The method of claim 8 wherein the at least one voice mail command provided by the wireless voice mail menu but not provided by the wireline voice mail menu comprises a play-slower command and a play-faster command.

10. The method of claim 1 wherein the wireless voice mail menu and the wireline voice mail menu differ in which numeric keys correspond to set of voice mail navigation commands.

11. The method of claim 10 wherein the set of voice mail navigation commands comprise a save command, a delete command, a reverse command and a skip forward command.

12. The method of claim 1 wherein incoming calls are processed differently in the first mode than the second mode.

13. A system comprising:
a voice mail system that provides a voice mail service, the voice mail system providing a first mode to navigate the voice mail service using a wireless voice mail menu and a second mode to navigate the voice mail service using a wireline voice mail menu.

14. The system of claim 13 wherein the voice mail service is a wireless voice mail service.

15. The system of claim 14 wherein the voice mail system is to:
receive, from a user, at least one command from the wireline voice mail menu; and
navigate the wireless voice mail service for the user based on the at least one command from the wireline voice mail menu.

16. The system of claim 13 wherein the voice mail system enables a user to select between the first mode and the second mode to navigate the voice mail service.

17. The system of claim 13 wherein the voice mail system enables a user to toggle between the first mode and the second mode.

18. The system of claim 13 wherein the wireline voice mail menu provides at least one voice mail command that is not provided by the wireless voice mail menu.

19. The system of claim 13 wherein the wireless voice mail menu provides at least one voice mail command that is not provided by the wireline voice mail menu.

20. A computer-readable medium which encodes computer-readable program code to cause a voice mail system, which provides a voice mail service, to:
provide a first mode to navigate the voice mail service using a wireless voice mail menu; and
provide a second mode to navigate the voice mail service using a wireline voice mail menu.
